(19) United States
(12) Patent Application Publication
(10) Pub. No.: US 2023/0149837 A1
(43) Pub. Date: May 18, 2023

(54) FILTER CARTRIDGE, AND METHOD OF RETROFITTING FILTER HOUSING

(71) Applicant: ENTEGRIS, INC., Billerica, MA (US)

(72) Inventors: Barry Lee Gregerson, Deephaven, MN (US); Jeffrey J. McKenzie, Watertown, MN (US); James C. Linder, Victoria, MN (US); Hayden Lincicome, Waltham, MA (US); John A. Leys, Chaska, MN (US)

(21) Appl. No.: 17/981,571

(22) Filed: Nov. 7, 2022

Related U.S. Application Data
(60) Provisional application No. 63/279,293, filed on Nov. 15, 2021.

(51) Int. Cl. B01D 27/10

(52) U.S. Cl. CPC B01D 27/106; B01D 2201/29; B01D 2201/304

(57) ABSTRACT

A removable filter cartridge includes a filter housing containing a filter, a sealing valve coupled to an open end of the filter housing and configured to removably couple the removable filter cartridge to a filter head. The sealing valve has an open position and a closed position that seals the filter housing, and is configured to maintain a seal of the filter housing while uncoupled from the filter head. A sealing valve includes a first end to be removably coupled to a filter head and a second end to be coupled to a filter housing to form a removable filter cartridge. A method of retrofitting a filter housing includes removing the filter housing from a filter head, coupling a sealing valve to the filter housing to form a removable filter cartridge, and removably coupling the removable filter cartridge to the filter head.

### CROSS-REFERENCE TO RELATED APPLICATIONS

This application claims the benefit under 35 USC 119 of U.S. Provisional Patent Application No. 63/279,293, filed Nov. 15, 2021, the disclosure of which is hereby incorporated herein by reference in its entirety.

### FIELD

This disclosure generally relates a filter assembly. More particularly, this disclosure relates to a removable filter cartridge in a filter assembly.

### BACKGROUND

Filters can be employed in semiconductor manufacturing to remove contaminants from a fluid. A filter head can direct a fluid (e.g., liquid, water, or the like) through a removable filter. The filter can be configured to remove containment such as, for example, solids as the liquid passes through the filter. In particular, a filter can be used to remove solid containments from a liquid as the liquid passes through the filter. A filter becomes saturated with trapped containments (e.g., solids) over time and is then replaced. Conventionally, the housing of the filter is drained and then removed and replaced with a new filter.

### SUMMARY

In an embodiment, a removable filter cartridge includes a filter housing with an internal volume containing a filter configured to filter a liquid and a sealing valve. The sealing valve includes a first end coupled to an open end of the filter housing and a second end configured to removably couple the removable filter cartridge to a filter head. The sealing valve is configured to be actuated between an open position and a closed position by one of sliding the sealing valve and rotating the filter housing. In the open position, the sealing valve allows liquid flow into and out of the internal volume of the filter housing. In the closed position, the sealing valve seals the internal volume of the filter housing. The sealing valve is configured to be actuated from the open position to the closed position while the sealing valve is removably coupled to the filter head and to maintain the seal while the removable filter cartridge remains uncoupled.

In an embodiment, a sealing valve for a removable filter cartridge includes a first end and a second end. The first end configured to be removably coupled to a filter head. The second end is configured to couple the sealing valve to a filter housing to form the removable filter cartridge. The sealing valve is configured to be actuated between an open position and a closed position by one of sliding the sealing valve and rotating the filter housing. In the closed position, the sealing valve seals the internal volume of the filter housing. The sealing valve is configured to be actuated from the open position to the closed position while the sealing valve is removably coupled to the filter head and to maintain the seal while the removable filter cartridge remains uncoupled.

In an embodiment, a method of retrofitting a filter housing includes removing the filter housing from a filter head. The removing of the filter housing form the filter head includes uncoupling an open end of the filter housing from the filter head. The method also includes coupling a first end of a sealing valve to the open end of the filter housing to form a removable filter cartridge, and removably coupling the removable filter cartridge to the filter head which includes removably coupling a second end of the sealing valve to the filter head. The sealing valve is configured to be actuated between an open position and a closed position by one of sliding the sealing valve and rotating the filter housing. In the closed position, the sealing valve seals the internal volume of the filter housing. The sealing valve is configured to be actuated from the open position to the closed position while the sealing valve is removably.

### DRAWINGS

FIG. 1 is a front perspective view of an embodiment of a filter assembly.

FIG. 2 is an exploded view of the filter assembly of FIG. 1, according to an embodiment.

FIG. 3 is a top view of the filter assembly of FIG. 1, according to an embodiment.

FIG. 4A is a cross sectional view of a sealing valve of the filter assembly in FIG. 2 in an open position, according to an embodiment.

FIG. 4B is a cross sectional view of the sealing valve in FIG. 4A in a closed position, according to an embodiment.

FIG. 5 is an exploded view of a valve plate of a sealing valve of a filter assembly, according to an embodiment.

FIG. 6 is a cross sectional view of the filter assembly along the line VI-VI in FIG. 3 in an open position, according to an embodiment.

FIG. 7 is a cross sectional view of the filter assembly in FIG. 6 in a closed position, according to an embodiment.

FIG. 8 is a front perspective view of another embodiment of a filter assembly.

FIG. 9 is an exploded view of the filter assembly of FIG. 8, according to an embodiment.

FIG. 10 is an exploded view of a sealing valve of the filter assembly in FIG. 8, according to an embodiment.

FIG. 11 is a cross sectional view of the filter assembly in FIG. 8 in an open position, according to an embodiment.

FIG. 12 is a cross sectional view of the filter assembly in FIG. 8 in a closed position, according to an embodiment.

FIG. 13 is a block flow diagram of a method of retrofitting a filter housing

Like numbers represent like features.

### DETAILED DESCRIPTION

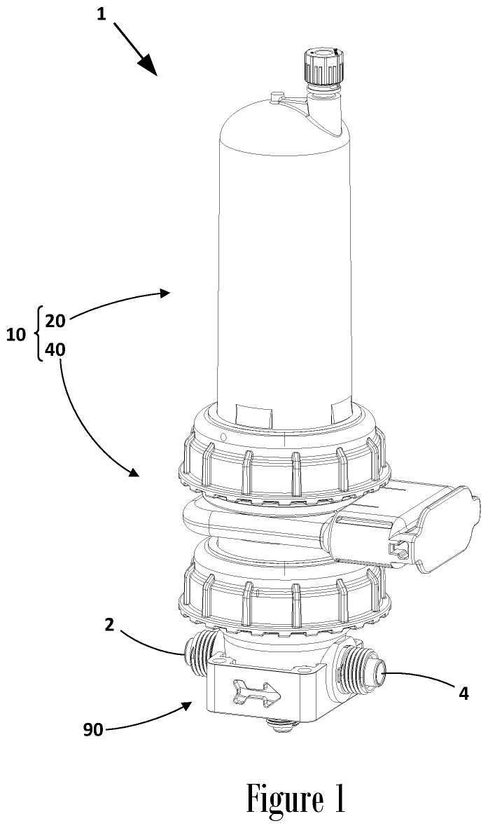

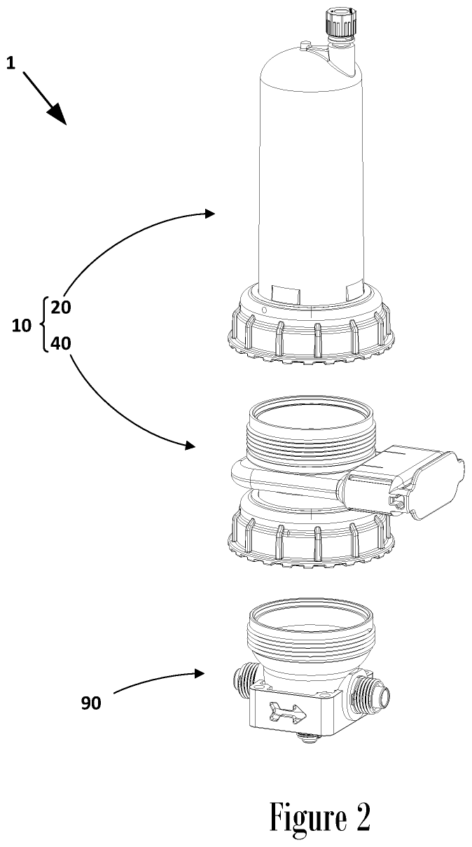

FIGS. 1 and 2 show an embodiment of a filter assembly 1. FIG. 1 is a front perspective view of the filter assembly 1. The filter assembly 1 includes a fluid inlet 2 and a fluid outlet 4. A fluid to be filtered is supplied to the fluid inlet 2, is filtered by the filter assembly 1, and then the filtered fluid is directed out from the fluid outlet 4 of the filter assembly 1. The filter assembly 1 removes solids from the fluid as the fluid passes through. In an embodiment, the fluid is liquid or mostly liquid. For example, the liquid may be water (e.g., deionized water), HCl, HNO₃, isopropyl alcohol, or the like. In an embodiment, the fluid is water. The filter assembly 1 includes a removable filter cartridge 10 that is coupled to a filter head 90. The removed solids remain within the filter cartridge 10. The filter head 90 includes the fluid inlet 2 and the fluid outlet 4 of the filter assembly 1.

The removable filter cartridge 10 is configured to be removed from the filter head 90. For example, the removable filter cartridge 10 is removed when due for replacement. The removable filter cartridge 10 may be due for replacement after performing a predetermined amount of filtering. For example, after the removable filter cartridge 10 has filtered predetermined amount of fluid, has filtered a predetermined amount of material from the fluid, has been in use for a predetermined amount of time, has reached a particular saturation of filtered material, etc.

The removable filter cartridge 10 includes a filter housing 20 and a sealing valve 40. The sealing valve 40 is coupled to the filter housing 20 to form the removable filter cartridge 10. The sealing valve 40 removably couples the removable filter cartridge 10 to the filter head 90. As shown in FIG. 1, the filter housing 20 is removably coupled to the filter head 90 by the sealing valve 40.

FIG. 2 is an exploded view of the removable filter cartridge 10. FIG. 2 shows the filter housing 20, sealing valve 40, and filter head 90 when uncoupled from each other. In the illustrated embodiment, the sealing valve 40 is uncoupled from the filter head 90 by being unscrewed from the filter head 90, and the filter housing 20 is uncoupled from the sealing valve 40 by being unscrewed from the filter head 90.

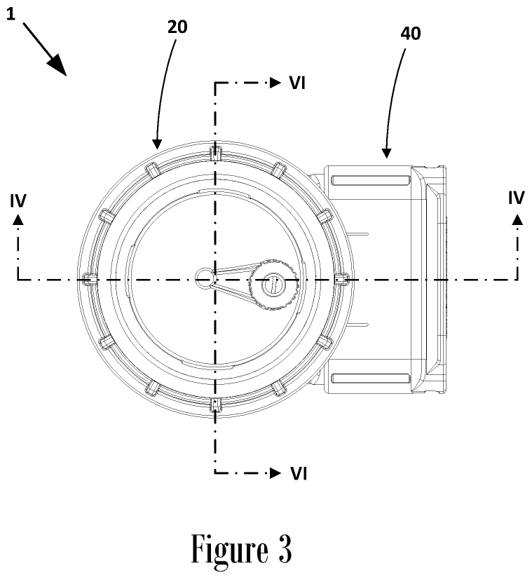

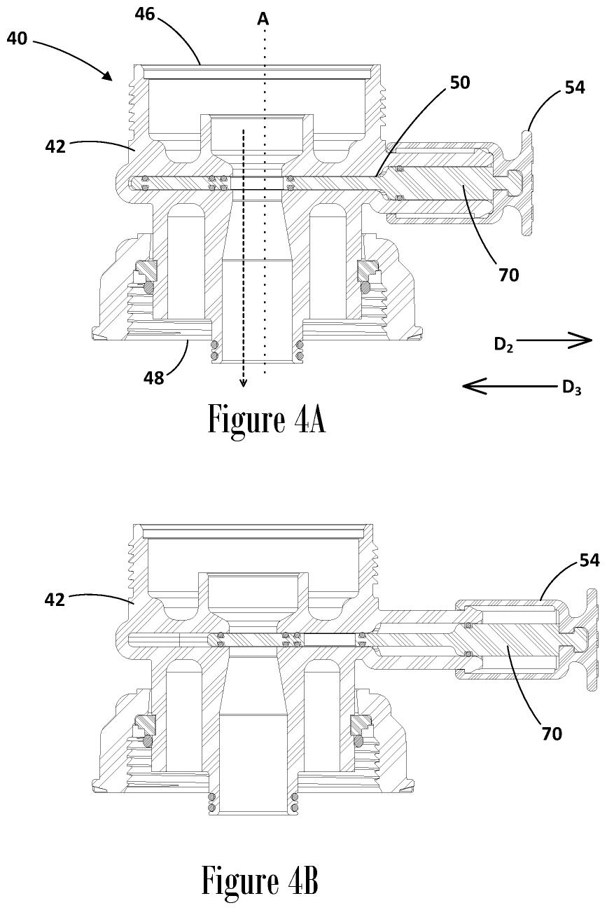

FIG. 3 is a top view of the filter assembly 1. The sealing valve 40 has an open position and a closed position. For example, the sealing valve 40 is configured to be moved between its open position and closed person by hand. FIG. 4A is a vertical cross-sectional view of sealing valve 40 in the open position. FIG. 4B is a vertical cross-sectional view of sealing valve 40 in the closed position. For example, the vertical cross-sectional view in FIGS. 4A and 4B is along the cross-section indicated by the line IV-IV in FIG. 3. The sealing valve 40 includes a valve body 42 and a valve plate 70 that is slidable in the valve body 42. The sealing valve 40 has an open position and a closed position. In the open position, the sealing valve 40 is configured to allow fluid to flow through the sealing valve 40. In the closed position, the sealing valve 40 is configured to block flow through the sealing valve 40.

The sealing valve 40 has a first end 46 and a second end 48 opposite to the first end 46. For example, the valve body 42 includes the first end 46 and the second end 48 of the sealing valve 40. The valve body 42 includes an opening 50 that extends through a side 52 of the valve body 42. The side 52 extends between the first end 46 and the second end 48 of the sealing valve 40. The valve plate 70 extends into and through the opening 50 in the side of the valve body 42.

The sealing valve 40 is configured to be actuated between the open position and the closed position by sliding the valve plate 70. In particular, the valve plate 70 is actuated between the open position and the closed position by sliding the valve plate 70 within the valve body 42. The valve plate 70 moves between the closed position and the open position by being slid relative to the valve body 42. For example, the valve plate 70 is changed between the closed position and the open position by moving the position of the valve plate 70 within the valve body 42 (e.g., changing the position of the valve plate 70 in the opening 50 of the valve body 42). The valve body 42 has a substantially cylindrical shape with an axis A. The axis A being the vertical axis of the cylindrical shape. The valve plate 70 is actuated between the closed position and the open position by moving the valve plate 70 in along a direction (e.g., along direction D₂) perpendicular to the axis A. For example, actuated from closed to open by moving in direction D₂ and from open to closed by moving in an opposite direction D₃.

In the illustrated embodiment, the valve plate 70 is moved from the open position (FIG. 4A) to the closed position (FIG. 4B) by the valve plate 70 being pulled away from the valve body 42, and is moved from the closed position to the open position by pushing the handle 54 closer to the valve body 42. For example, the length of the valve plate 70 disposed in the valve body 42 is changed to change valve plate 70 between its open and closed positions.

The sealing valve 40 includes a handle 54 affixed to the valve plate 70. The handle 54 is used to slide the valve plate 70 between the open position (FIG. 4A) and the closed position (FIG. 4B). A human operator (e.g., technician, etc.) can push and pull the handle 54 to move the sealing valve 40 between its open and closed positions. The handle 54 is a first one of pushed or pulled to move the valve plate 70 from its open position to its closed position and is the other one of pushed or pulled to move the valve plate 70 from its closed position to its open position. In the illustrated embodiment, the handle 54 is pushed towards the valve body 42 (e.g., moved closer to the valve body 42) to move the valve plate 70 from its closed position to its open positioned and is pulled away from the valve body 42 (e.g., moved farther away from the valve body 42) to move the valve plate 70 from its open position back to its closed position.

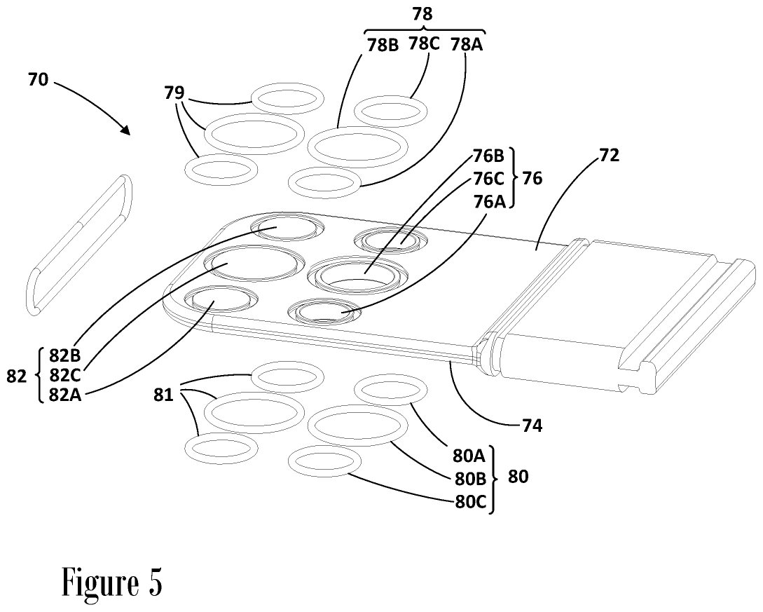

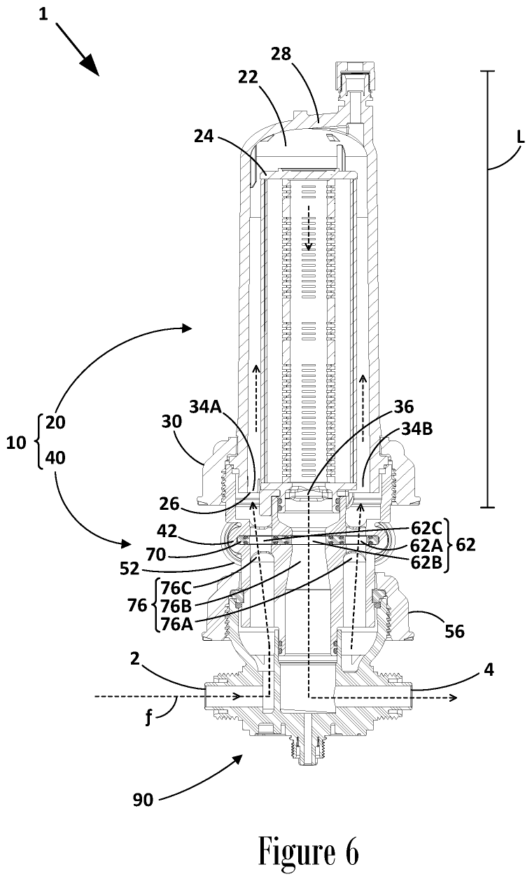

FIG. 5 is an exploded perspective view of the valve plate 70. As shown in FIG. 5, the valve plate 70 has a planar shape. The valve plate 70 has a first side 72 (e.g., a top side) and a second side 74 (e.g., a bottom side). The second side 74 is generally obscured in FIG. 5 (e.g., second side 74 is shown in FIG. 6). The valve plate 70 includes through holes 76 and configured to allow fluid to flow through the valve plate 70 when in the open position. Each of the through holes 76 separately extends through the valve plate 70 from the first side 72 to the second side 74. The through holes 76 in the valve plate 70 include at least one inlet through hole 76A, 76C and at least one outlet through hole 76B. In the illustrated embodiment, the valve plate 70 includes two inlet through holes 76A, 76C and one outlet through hole 76B. The valve plate 70 including a first through hole 76A that is an inlet through hole, a second through hole 76B that is an outlet through hole, and a third through hole 76C that is another inlet through hole. It should be appreciated that the valve plate 70 in other embodiments may have a different number inlet and/or outlet through holes 76A, 76B, 76C (e.g., one inlet through hole, two outlet through holes, etc.) based on the configuration the filter housing 20 and the filter head 90.

As shown in FIG. 5, the valve plate 70 can include a respective pair of seals 78, 80 for each through hole 76. The seals 78, 80 include first seals 78 provided on the first side 72 of the valve plate 70 and second seals 80 provided on the second side 74 of the valve plate 70. Each seal 78, 80 surrounds its respective through hole 76 on its respective side 72, 74. The seals 78, 80 for the through holes 76 are configured to provide sealing between the valve plate 70 and the valve body 40 when in the open position (e.g., see FIGS. 4A and 6). The first seals 78 provide sealing between the valve plate 70 and the valve body 42 along the top side 72 of the valve plate 70 in the open position, and second seals 80 provide sealing between the valve plate 70 and the valve body 42 along the bottom side 74 of the valve plate 70 in the open position.

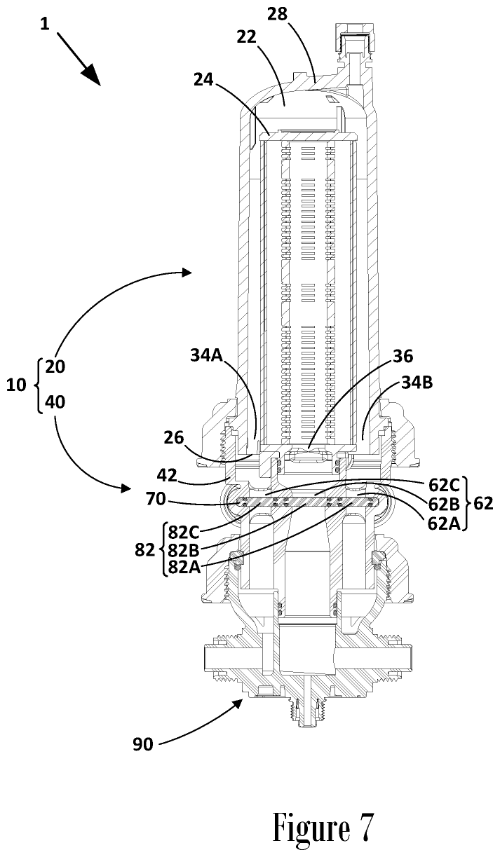

In the illustrated embodiment, the valve plate 70 includes a respective first seal 78 on the first side 72 and a respective second seal 80 on the second side 74 for each through hole 76 (e.g., shown FIGS. 6 and 7). For example, the valve plate 70 includes a first pair of first and second seals 78A, 80A for a first through hole 76A, a second pair of first and second seals 78B, 80B for a second through hole 76B, and a third pair of first and second seals 78C, 80C for a third through hole 76C.

The valve plate 70 includes portions 82 configured to block fluid flow through the valve plate 70 when the valve plate 70 is in the closed position (shown in FIG. 4B). The portions 82 are solid portions of the valve plate 70 and may be referred to as blocking portions. The valve plate 70 can include a corresponding blocking portion 82 for each through hole 7 in the valve plate 70. As shown in FIG. 5, the valve plate 70 can include a first blocking portion 82A that corresponds to the first through hole 72A, a second blocking portion 82B that correspond to the second through hole 72B, and a third blocking portion 82C that corresponds to the third through hole 72C.

As shown in FIG. 5, the valve plate 70 can include a respective pair of seals 79, 81 on the valve plate 70 for each blocking portion 82 in a similar manner to the seals 78, 80 for the through holes 76. The seals 79, 81 for the blocking portions 82 are configured to provide sealing between the valve body 40 and the valve plate 70 when in the closed position. First seals 79 for the blocking portions 82 provide sealing between the valve plate 70 and the valve body 42 along the top side 72 of the valve plate 70 in the closed position, and the second seals 81 for the blocking portions 82 provide sealing between the valve plate 70 and the valve body 42 along the bottom side 74 of the valve plate 70 in the closed position.

For example, for each blocking portion 82, a first seal 79 surrounds its respective blocking portion 82 on the first side 72 of the valve plate 70 and a second seal 81 surrounds its respective blocking portion 82 on the second side 74 of the valve plate 70. In another embodiment, the valve plate 70 may include a different number of blocking portions 82 (e.g., two blocking portions, etc.) as similarly discussed above for the through holes 72.

The seals 78, 79, 80, 81 can be made of an elastomer different from the polymer of the valve body 42 and/or the valve plate 70 and are embedded in their respective side 78, 79, 80, 81 of the valve plate 70 (e.g., press fit into a respective groove in the valve plate 70). Examples of the polymer for the valve plate 70 and/or valve body 42 may include, but are not limited to, PFA, PTFE, modified PTFE, PP, and PE. For example, FIGS. 4A and 4B show the seals 78, 79, 80, 81 embedded in the assembled valve plate 70. In other embodiments, the seals 78, 79, 80, 81 may each be an integral ridge formed in the valve plate 70.

FIG. 6 is a vertical cross-sectional view of the filter assembly 1. For example, the vertical cross-section of FIG. 6 can be along the line VI-VI in FIG. 3. For illustrative purposes, the filter head 90 in FIG. 6 is rotated relative to the removable filter cartridge 10 (e.g., rotated 90 degrees clockwise) from its position as shown in FIG. 1. FIG. 6 shows the sealing valve 40 in the open position (e.g., as shown in FIG. 4A) that allows the fluid f to pass through the filter assembly 1.

The filter housing 20 includes an internal volume 22 that contains a filter 24. Dashed lines are provided in FIG. 6 to illustrate the flow of the fluid f through the filter assembly 1 In the open position, fluid f from the filter head 90 is allowed to pass through the sealing valve 40 to the filter housing 20, pass through the filter housing 20, and then pass from the filter housing 40 through the sealing valve 40 back to the filter head 90. The open position of the sealing valve 40 is configured to allow the fluid to flow into and out of the internal volume 22 of the filter housing 20. The filter 24 filters fluid f as it passes through the removable filter cartridge 10. The fluid f is filtered as it passes through the filter housing 40, such that the fluid f flowing back to the filter head 20 (and then out through the fluid outlet 4) is filtered fluid.

As shown in the illustrated embodiment, the filter housing 20 may have a bowl shape. The filter housing 20 has an open end 26 and a closed end 28. The open end 26 and the closed end 28 of the filter housing 20 are opposite ends of the length L of the filter housing 20. The open end 26 may also be referred to as a fluid inlet-outlet as the fluid f enters and exits the filter housing 20 through its open end 26. As shown in FIG. 6, the first end 46 of the sealing valve 40 is configured to be coupled to the filter housing 20. The first end 46 of the sealing valve 46 is coupled to the open end 26 of the filter housing 20.

In the illustrated embodiment, the first end 46 of the sealing valve 40 is coupled to the filter housing 20 by threads on the sealing valve 40 and the filter housing 20. For example, the filter housing 20 is configured to be screwed onto the sealing valve 40 by screwing a coupling nut 30 of the filter housing 20 onto the sealing valve 40. In an embodiment, the threads of the sealing valve 40 (e.g., threads of the coupling nut 56 of the sealing valve 40) and the threads of the filter housing 20 (e.g., threads of the coupling nut 30) have the same structure (e.g., thread size, thread spacing, etc.). It should be appreciated that sealing valve 40 in other embodiments may be coupled to the filter housing 20 in a different manner than being screwed together via threads. In another embodiment, the sealing valve 40 and the filter housing 20 may be coupled by, for example but not limited to, clamping (e.g., with a tri-coupler, etc.) or bonding (e.g., thermal bonding of the sealing valve 40 to the filter housing 20, etc.).

The sealing valve 40 is configured to be removably coupled to the filter head 90. The second end 48 of the sealing valve 40 is removably coupled to the filter head 90. In the illustrated embodiment, the sealing valve 40 includes threads that screw into threads on the filter head 90 to removably couple the removable filter cartridge 10 to the filter head 90. As shown in FIG. 6, the sealing valve 40 can include a coupling nut 56 with threads that screw onto to the threads of the filter head 90. It should be appreciated that the sealing valve 40 in other embodiments may configured to removably couple to the filter head 90 in a different manner than via threads. In an embodiment, the sealing valve 40 may be configured to removably couple to the filter head 90 by, for example but not limited to, a coupler (e.g., a tri-coupler, or the like).

As shown in FIG. 6, the sealing valve 40 can include a circumferential groove 58 and a snap ring 60 disposed in the circumferential groove 58 of the valve body 42. The circumferential groove 58 extends around a circumference of the sealing valve 40. The snap ring 60 is configured to be compressed between the sealing valve 40 and the filter head 90 when the sealing valve 40 is removably coupled to the filter head 90. In the illustrated embodiment, the snap ring 60 is compressed between the coupling nut 56 of the sealing valve 40 and the filter head 90 when the coupling nut 56 is screwed onto the filter head 90.

The filter housing 20 includes a first inlet 34A, a second inlet 34B, and an outlet 36 provided at the open end 26 of the filter housing 20. For example, the first inlet 34A, the second inlet 34B, and the outlet 36 are different passages extending into the filter housing 20 from the open end 26. In the illustrated embodiment, the outlet 36 is disposed radially between the first inlet 34A and the second inlet 34B. The filter housing 20 is configured such that the fluid f enters the filter housing 20 through the inlets 34A, 34B and exits the filter housing 20 (e.g., after passing through and being filtered by the filter 24) through the outlet 36. It should be appreciated that the filter housing 20 in an embodiment may have a different number of inlets and/or outlets than 3. In some embodiments, the filter housing 20 may include one or more inlets 34A, 34B and one or more outlets 36. In an embodiment, the filter housing 20 may include one inlet 34A and one outlet 34A. In another embodiment, the filter housing 20 may include two or more inlets 34A, 34B and/or two or more outlets 36.

The valve body 42 includes passages 62 for the inlets and outlet(s) 34A, 34B, 36 in the open end 26 of the filter housing 20. Each of the passages 62 extends through the valve body 42. As shown in FIG. 6, the passages 62 in the valve body 42 include a first passage 62A, a second passage 62C, and a third passage 62B that each separately extend through the valve body 42. Each of the passages 62 extends through the valve body 42 from the first end 46 to the second end 48.

The passages 62 in the valve body 42 include at least one inlet passage 62A, 62C and at least outlet passage 62B. The inlet passages 62A, 62C each connect the fluid inlet 2 of the filter head 90 (e.g., the passage in the filter head 90 extending from the fluid inlet 2) to the inlet(s) 34A, 34B of the filter housing 20. The outlet passage 62B connects the outlet 36 of the filter housing 20 (e.g., the passage in the filter head 90 extending from the fluid outlet 4) to the fluid outlet 4 of the filter head 90.

As shown by the dashed lines in FIG. 6, the inlet passages 62A, 62C fluidly connect the fluid inlet 2 of the filter head 90 to the first and second inlets 34A, 34B of the filter housing 20, and the outlet passage 62C fluidly connects the outlet 36 of the filter housing 20 to the fluid outlet 4 of the filter head 90. For example, the first and third passages 62A, 62C direct the fluid f supplied from the passage of the fluid inlet 2 of the filter head 90 to the inlets 34A, 34B of the filter housing 20. For example, the second passage 62B directs the filtered fluid f from the outlet 36 to the passage in the filter head 90 for the fluid outlet 4.

The sealing valve 40 is configured such that when in its open position (e.g., as shown in FIGS. 4A and 6), the valve plate 70 is disposed in the valve body 42 such the through holes 76 in the valve plate 70 are aligned with the passages 68. A through hole 76 is “aligned” as the through hole 76 is disposed in its respective passage 62A, 62B, 62C. When aligned with its respective passage 68, fluid can flow through said passage 68 by passing through said through hole 76. As shown in FIG. 6, when the in the open position, the first through hole 76A in the valve plate 70 is aligned with the first passage 62A, the second through hole 76B in the valve plate 70 aligns with the second passage 62B, and the third through hole 76C aligns with the second passage 62C.

It should be appreciated that the filter housing 20 in other embodiments may have a different number of inlets and outlets 34A, 34B, 36 at its open end 26 than three (e.g., one inlet, more than two inlets, multiple outlets etc.). In such embodiments, the sealing valve 40 may have a different number of passages 62A, 62B, 62C than three (e.g., same number of corresponding passages as inlets and outlets in the filter housing 20, two of the passages, etc.).

FIG. 7 is a vertical cross-sectional view of the filter assembly 1 with the sealing valve 40 in the closed position (e.g., as shown in FIG. 4B). FIG. 7 is similar view to FIG. 6 except that the sealing valve 40 is moved to its closed position. The sealing valve 40 in the closed position is configured to block fluid f from flowing through the filter assembly 1. As shown in FIG. 7, the seal valve 40 in its closed position blocks the fluid from passing through the seal valve 40 between filter housing 20 and the filter heat 90 (e.g., blocks fluid from the filter head 90 to the filter housing 20 and blocks fluid flow from the filter housing 20 to the filter head 90). The removable filter cartridge 10 is configured to have the seal valve 40 actuated to the closed position while still removably coupled to the filter head 90. When the valve seal 40 is changed to its closed position (e.g., the valve plate 70 is slide/moved to the closed position), the valve seal 40 in the closed position seals the internal volume 22 of the filter housing 20. The closed valve seal 40 blocks flow of fluid into and out of the open end 26 of the filter housing 20 and seals the open end 26 of the filter housing 20.

The valve plate 70 blocks each of the passages 62 in the closed position. The sliding of the valve plate 70 into the closed position causes the through holes 76 in the valve plate 70 to no longer be aligned with their respective passage 62. The sliding of the valve plate 70 into the closed position moves the blocking portions 82 of the valve plate 70 to be disposed in the passages 62. Each of the passages 62 are blocked by the blocking portions 82 of the valve plate 70. For example, each blocking portions 82 extends across a corresponding one of the across the passages 62. As shown in FIG. 7, the first blocking portion 82A of the valve plate 70 extends across and blocks the first passage 62A, the second blocking portion 82B of the valve plate 70 extends across and blocks the second passage 62B, and the third blocking portion 82C of the plate 70 extends across and blocks the third passage 62C.

When the removable filter cartridge 10 is uncoupled from the filter head 90 (e.g., the coupled filter housing 20 and sealing valve 40 are uncoupled/unscrewed from the filter head 90), the sealing valve 40 is configured to maintain the sealing of the internal volume 22. The sealing valve 40 is configured to maintain the sealing of filter housing 20 while the cartridge remains uncoupled from a filter head. In particular, the closing of the sealing valve 40 seals the filter housing 20 such that any of the liquid in the internal volume 22 is trapped within the removable filter cartridge 10. This is advantageous over previous configuration in that the removable filter cartridge 10 can be removed more quickly without having to be drained of liquid.

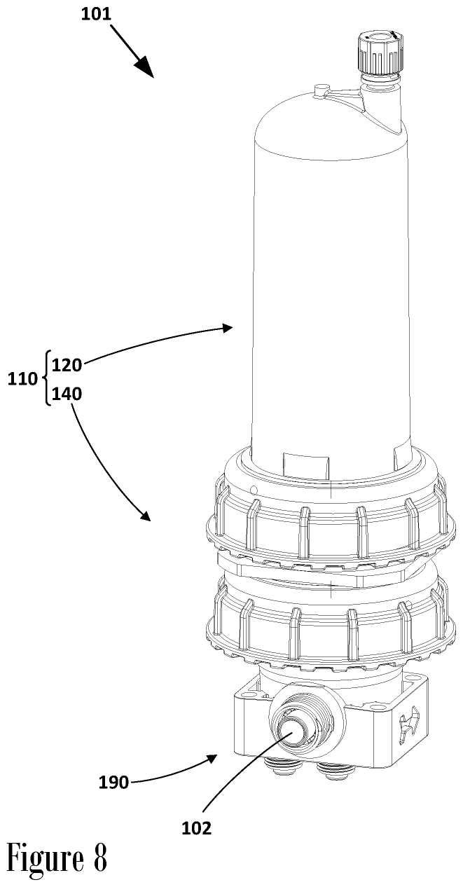

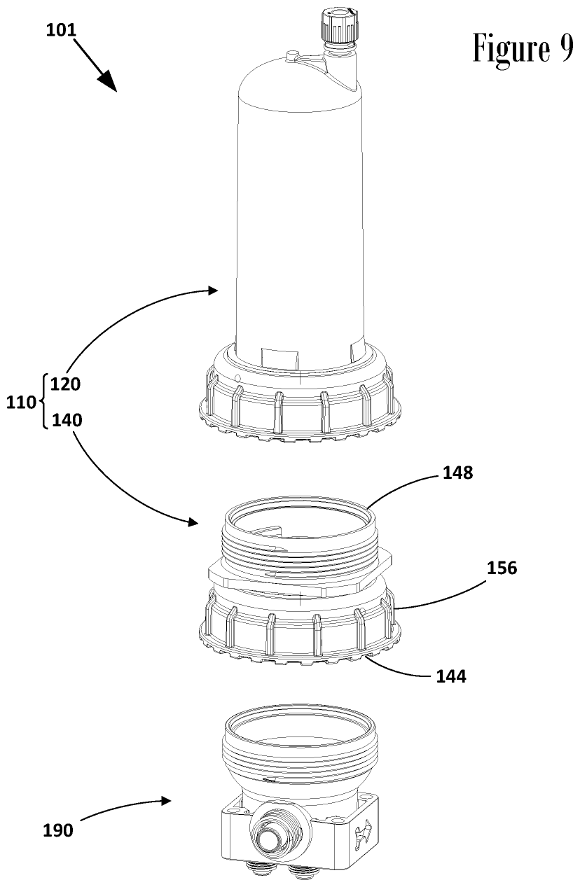

FIGS. 8 and 9 show another embodiment of a filter assembly 101. FIG. 8 is a side perspective view of the filter assembly 101. FIG. 9 is an exploded view of the filter assembly 101. The filter assembly 101 includes a removable filter cartridge 110 that is coupled to a filter head 190 and includes a filter housing 120 and a sealing valve 140. The filter assembly 101 generally has a similar configuration to the filter assembly 1 in FIGS. 1-8 except for the sealing valve 140. For example, the filter head 90 includes a fluid inlet 102 and a fluid outlet (obscured in FIGS. 7 and 9) of the filter assembly 101 and is configured to supply the fluid through the removable filter cartridge 110; and the removable filter cartridge 110 filters the fluid passing that passes through similar to the removable filter cartridge 1 in FIG. 1. For example, the sealing valve 140 has a first end 146 coupled to the filter housing 120 and a second end 148 removably coupled to the filter head 90. The filter assembly 101 can have features similar to the filter assembly 1 in FIGS. 1-8 unless described otherwise.

The filter housing 120 and the filter head 190 have a similar configuration to the filter head 90 and filter housing 20 of the filter assembly 1 in FIGS. 1-8. It should be appreciated that the filter housing 120 and/or the filter head 190 may be different in other embodiments as similarly described for the filter housing 20 and the filter head 90 in FIGS. 1-8.

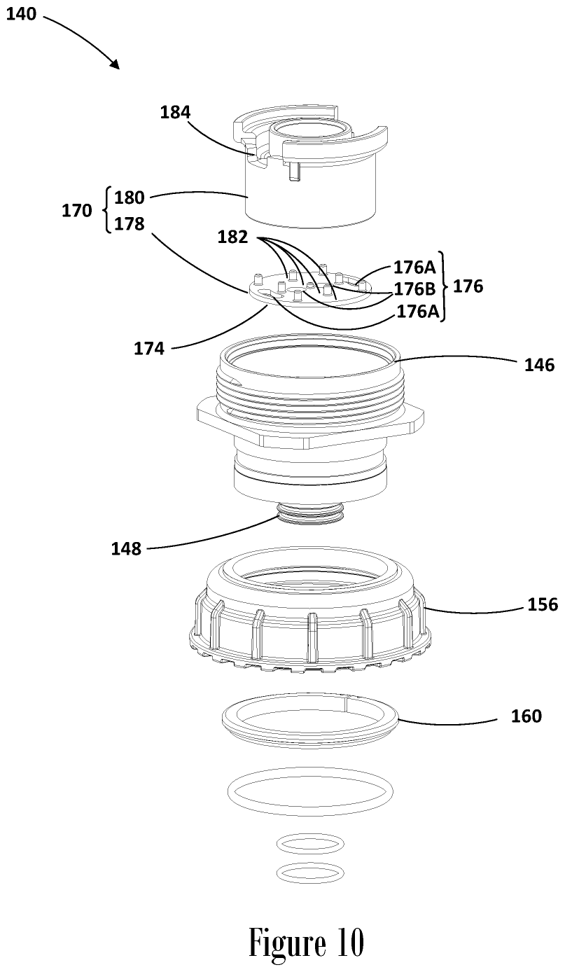

FIG. 10 is an exploded view of the sealing valve 140. The sealing valve 140 has an open position and a closed position. In the open position, the sealing valve 140 is configured to allow fluid to flow through the sealing valve 140. In the closed position, the sealing valve 140 is configured to block flow through the sealing valve 140. The sealing valve 140 has a first end 146 and a second end 148 opposite to the first end 146. For example, the valve body 142 includes the first end 146 and the second end 148 of the sealing valve 140.

The sealing valve 140 is configured to be removably coupled to the filter head 190 as similarly discussed for the sealing valve 40 and filter head 90 in FIGS. 1-8. In the illustrated embodiment, the second end 148 of the sealing valve 140 is removably coupled to the filter head 190 via a coupling nut 156 of the sealing valve 140. The sealing valve 140 can include the coupling nut 156 and a snap ring 160 (shown in FIG. 10) for coupling the sealing valve 140 to the filter head 190. For example, the threads of the coupling nut 156 are screwed into threads on the filter head 190. In an embodiment, the sealing valve 140 may be configured to removably couple to the filter head 190 by, for example but not limited to, a coupler (e.g., a tri-coupler, or the like).

The sealing valve 140 includes a valve body 142 and a valve gate 170. The valve gate 170 is disposed within the valve body 142 and is rotatable within the valve body 142. The sealing valve 140 is configured to be actuated between the open position and the closed position by rotating the valve gate 170. In particular, the sealing valve 140 is actuated between the open position and the closed position by rotating the valve gate 170 within the valve body 142. The valve gate 170 moves between the closed position and the open position by being rotated relative to the valve body 142.

For example, the sealing valve is changed between the closed position and the open position by rotating the valve gate 170 within the valve body 142.

In the illustrated embodiment, the valve gate 170 is actuated between open and closed by being rotated by 90 degrees. For example, the valve gate 170 is moved from the open position to the closed position by the valve gate 170 being rotated by 90 degrees relative to the valve body 42, and is moved from the closed position to the open position by rotating the valve gate 170 either 90 degrees further (e.g., 180 degrees from its starting closed position) or 90 degrees in the opposite direction (e.g., returning the valve gate 170 to its starting closed position. In an embodiment, the valve gate 170 may be configured to be rotated by at least 45 degrees to move between the open and closed positions. The valve gate 170 is configured to be rotated by the filter housing 120 as discussed below. The filter housing 120 configured to be rotated by hand to actuate the sealing valve 140 by hand between the open and closed positions.

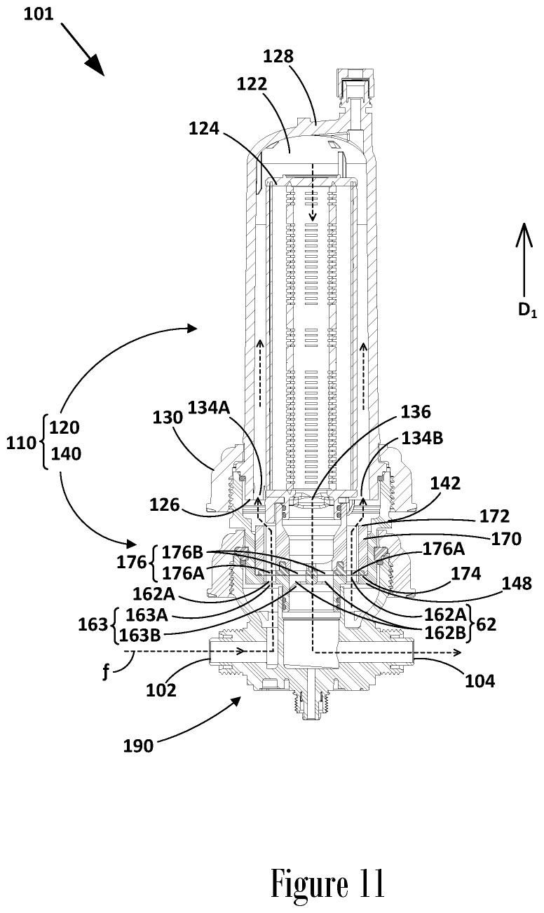

In the illustrated embodiment, the valve gate 170 includes a first side 172 (e.g., a top side) and a second side 174 (e.g., a bottom side) opposite to the first side 172. The second side 174 is generally obscured in FIG. 10 (e.g., second side 174 is shown in FIG. 11). The valve gate 170 includes a valve plate 178 disposed at the second side 174 of the valve gate 170. For example, the valve plate 178 provides the bottom surface of the valve gate 170. In the illustrated embodiment, the valve gate 170 includes a valve cylinder 180 and the valve plate 178 is an affixed to the bottom of the valve cylinder 180 to form the valve gate 170. In an embodiment, the valve plate 178 is made an elastomer. In another embodiment, the valve plate 178 and valve cylinder 180 may be formed as a single integral piece.

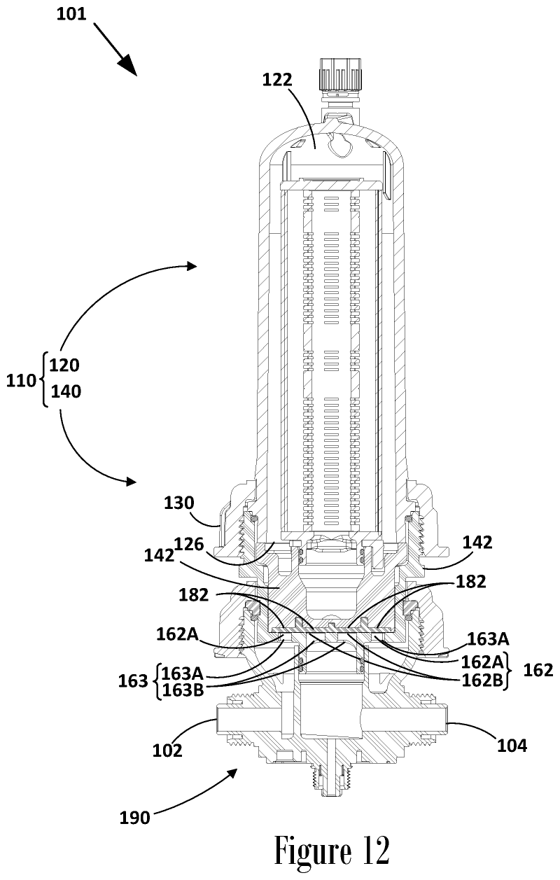

The valve plate 178 includes through holes 176 that extend through the valve plate 178. As shown in FIG. 10, the through holes 176 are provided along the same vertical plane. The through holes 176 are spaced apart from each other in the valve plate 178. The through holes 176 include inlet through holes 176A and outlet through holes 176B. The valve plate 178 also includes blocking portions 182 configured to block fluid flow through the valve gate 170 when the valve gate 170 is in the closed position (shown in FIG. 12). The portions 182 are solid portions of the valve gate 170 and may be referred to as blocking portions. The valve gate 170 includes a corresponding blocking portion 182 for each through hole 176 in the valve plate 170. The through holes 176 and blocking portions 182 are discussed in more detail below.

The bottom 174 of the valve gate 170 may include a seal around each of the through-holes 176 and/or blocking portions 182 similar to the valve plate 70 in FIG. 5. The seals may be embedded into the bottom of the valve gate 170 or integral to the valve gate 170. For example, the seals may be integral to the valve plate 178 (e.g., as shown in FIGS. 11 and 12)

In the illustrated embodiment, the valve gate 170 includes a key slot 184 for rotatably connecting the valve gate 170 to the filter housing 120. The key slot 184 is used to rotatably connect the valve gate 170 and the filter housing 120 such that rotation applied to the filter housing 120 also rotates the gate valve 170 within the valve body 142 (e.g., the gate valve 170 rotates with any rotation of the filter housing 120). The rotatable connection of the valve gate 170 and the filter housing 120 is discussed in more detail below.

FIG. 11 is a vertical cross-sectional view of the filter assembly 101. For example, the vertical cross-section of FIG. 11 is along a similar vertical plane to FIGS. 7 and 8. FIG. 11 shows the sealing valve 140 in the open position that allows the fluid f to pass through the filter assembly 101.

The filter housing 120 generally has the same configuration as the filter housing 120 of the filter assembly 1 in FIG. 7. When the sealing valve 140 is open, the fluid flows from the inlets 134A through the filter 124 disposed in the internal volume 122 of the filter housing 120, then the filtered fluid flows out of the filter housing 120 through the outlet 136. For example, the filter housing 120 includes the first inlet 134A, the second inlet 134B, and the outlet 136 provided at the open end 126 of the filter housing 120. In an embodiment, the filter housing 120 may be modified in a similar manner as discussed for the filter housing 20. For example, in some embodiments, the filter housing 20 may include one or more inlets 34A, 34B and one or more outlets 36.

The valve body 142 includes passages 162 for the inlets and outlet(s) 134A, 134B, 136 in the open end 126 of the filter housing 120. Each of the passages 162 extends through the valve body 142. In the open position, the passages 162 also each extend through the valve gate 170 as shown in FIG. 11. As shown in FIG. 11, the passages 162 in the valve body include a pair of inlet passages 162A and a pair of outlet passages 162B. Each of the passages 162 has an opening 163 disposed in the second end 148 of the sealing valve 140. For example, the inlet passages 162A each include a respective inlet opening 163A and the outlet passages 162B each include a respective outlet opening 163B. Fluid enters the inlet passages 162A (e.g., enters the sealing valve 140 from the valve head 190) through the inlet openings 163A and the filtered fluid exits the outlet passages 162B (e.g., exits the sealing valve 140 into the valve head 190) through the outlet openings 163A. It should be appreciated that there may be a different number of openings 163 in other embodiments. For example, the number of openings 163 can correspond with the number of passages 162 provided in a particular embodiment of the sealing valve 140.

As shown in FIG. 11, the passages 162 in the valve body 42 includes two inlet passages 162A and two outlet passages 162B that each separately extend through the bottom end 148 of the valve body 42. The passages 162 in the valve body 142 include at least one inlet passage 162A and at least outlet passage 162B. In the open position, the inlet passages 162A each connect the fluid inlet 102 of the filter head 190 (e.g., the passage in the filter head 90 extending from the fluid inlet 2) to the inlet(s) 134A, 134B of the filter housing 120. The outlet passages 162B connect the outlet 136 of the filter housing 20 to the fluid outlet 104 of the filter head 90 (e.g., the passage in the filter head 90 extending from the fluid outlet 104).

As shown by the dashed lines in FIG. 11, the inlet passages 162B fluidly connect the fluid inlet 102 of the filter head 190 to the first and second inlets 134A, 134B of the filter housing 20, and the outlet passages 162B fluidly connect the outlet 136 of the filter housing 120 to the fluid outlet 104 of the filter head 190. For example, the first and second inlet passages 162A direct the fluid f supplied from the passage of the fluid inlet 102 of the filter head 190 to the inlets 134A of the filter housing 120. For example, the first and second outlet passages 162 direct the filtered fluid f from the outlet 136 to the passage in the filter head 190 for the fluid outlet 104.

The sealing valve 140 is configured such that when in its open position (e.g., as shown in FIG. 11), the valve gate 170 is rotationally disposed in the valve body 142 such the through holes 176 in the valve gate 170 are aligned with the passages 168. In particular, in the valve gate 170 in the open position is rotated to a position in which its each of its through holes 176 are aligned with a respective one of the openings 163 of the passages 162. A through hole 176 is “aligned” when the through hole 176 is disposed in its respective passage 162. For example, when open, each through hole 176 in the valve plate 178 of the valve gate 170 is aligned with a respective one of the openings 163 in the valve body 142 of its respective passage 162. A through hole 167 and its respective opening 163 align by overlapping in the axial direction (e.g., direction D₁) of the sealing valve 1. This alignment allows for the working fluid to flow between the through hole 167 and its respective opening 163.

When aligned with its respective passage 168, fluid can flow through said passage 168 by passing through said through hole 176. As shown in FIG. 11, when the in the open position, a first inlet through hole 176A in the valve plate 178 is aligned with a first inlet passages 162A, the second inlet through hole 176A in the valve plate 178 aligns with a second inlet passage 162A, a first outlet through hole 176B aligns with a first outlet passage 162B, and a second outlet through 162B aligns with a second outlet passage 162B.

It should be appreciated that the filter housing 120 in other embodiments may have a different number of inlets and outlets 134A, 134B, 136 at its open end 126 than four (e.g., one inlet, more than two inlets, one outlet, more than two outlets, etc.). In such embodiments, the sealing valve 140 may have a different number of passages 162A, 162B than four (e.g., same number of corresponding passages as inlets and outlets in the filter housing 120, two of the passages, etc.).

FIG. 12 is a vertical cross-sectional view of the filter assembly 101 with the sealing valve 140 in the closed position. The filter housing 120 is rotationally connected to the valve gate 170 of the filter housing 120. FIG. 12 is similar view to FIG. 11 except that the sealing valve 140 is moved to its closed position. The sealing valve 140 is moved from its open position to its closed position by rotating the valve gate 170 within the valve body 142.

In the illustrated embodiment, the housing 120 has a projection 129 that is disposed in a key slot 184 of the valve gate 170. The projection 129 rotationally connecting the valve gate 170 and filter housing 120 such that rotation of the filter housing 120 rotates the valve gate 170. The filter housing 120 and the valve gate 170 configured to always rotate together in the assembled filter cartridge 110. The sealing valve 140 configured to be actuated between its open position (e.g., shown in FIG. 11) and its closed position (e.g., shown in FIG. 12) by rotating the filter housing 120.

In the illustrated embodiment, the coupling nut 130 couples the filter housing 120 to the sealing valve 140. The sealing valve 140 is moved from the open position to the closed position by partially unscrewing the coupling nut 130 (e.g., partially uncoupling the filter housing 120 and the sealing valve 140), rotating the filter housing 120, and then screwing the coupling nut 130 (e.g., re-fully coupling the filter housing 120 and the sealing valve 140). The coupling nut 130 is only unscrewed enough to allow the filter housing 120 to rotate relative to the valve body 142 of the sealing valve 140. The coupling nut 130 remains sufficiently screwed onto the sealing valve 140 to maintain the seal between the filter housing 120 and the sealing valve 140.

The sealing valve 140 in the closed position is configured to block fluid f from flowing through the filter assembly 101. As shown in FIG. 12, the seal valve 140 in its closed position blocks the fluid from passing through the seal valve 140 between the filter housing 120 and the filter head 190 (e.g., blocks fluid flow from the filter head 190 to the filter housing 20 and blocks fluid flow from the filter housing 120 to the filter head 190). The removable filter cartridge 110 is configured to have the seal valve 140 actuated to the closed position while still removably coupled to the filter head 190. When the valve seal 140 is changed to its closed position (e.g., the valve gate 170 is rotated/moved to the closed position), the valve seal 140 in the closed position seals the internal volume 122 of the filter housing 120. The closed valve seal 140 blocks flow of fluid into and out of the open end 126 of the filter housing 120 and seals the open end 126 of the filter housing 120.

The valve gate 170 blocks each of the passages 162 in the closed position. In particular, the valve gate 170 in the closed position blocks the openings 163 of the passages 162 in the valve body 142. The rotating of the valve gate 170 into the closed position causes the through holes 176 in the valve gate 170 to no longer be aligned with their respective passage 162. For example, the through holes 176 are each in rotated position relative to the opening 163 of their respective passageway 162. The rotation of the valve gate 170 into the closed position moves the blocking portions 182 of the valve gate 170 to be disposed in the passages 162. In particular, the rotation of the valve gate 170 moves the blocking portions 182 of the valve gate 170 to be disposed over the openings 163. The block portions 182 disposed over the openings 163 along the inside of the valve body 142.

Each of the passages 162 is blocked by a blocking portions 82 of the valve gate 170. For example, each blocking portions 182 extends across a corresponding one of the across the passages 162. As shown in FIG. 12, a first blocking portion 182 of the valve gate 170 extends across and blocks the first inlet passage 162A, a second blocking portion 182 of the valve plate 70 extends across and blocks the second inlet passage 162A, a third blocking portion 182 of the valve gate 170 extends across and blocks the first outlet passage 162B, and a fourth blocking portion 182 of the valve gate 170 extends across and blocks the second outlet passage 162B.

When the removable filter cartridge 110 is uncoupled from the filter head 180 (e.g., the coupled filter housing 120 and sealing valve 140 are uncoupled/unscrewed from the filter head 90), the sealing valve 140 is configured to maintain the sealing of the internal volume 122. The sealing valve 140 is configured to maintain the sealing of filter housing 120 while the cartridge remains uncoupled from a filter head. In particular, the closing of the sealing valve 140 seals the filter housing 120 such that any of the liquid in the internal volume 122 is trapped within the removable filter cartridge 110. This is advantageous over previous configuration in that the removable filter cartridge 110 can be removed more quickly without having to be drained of liquid.

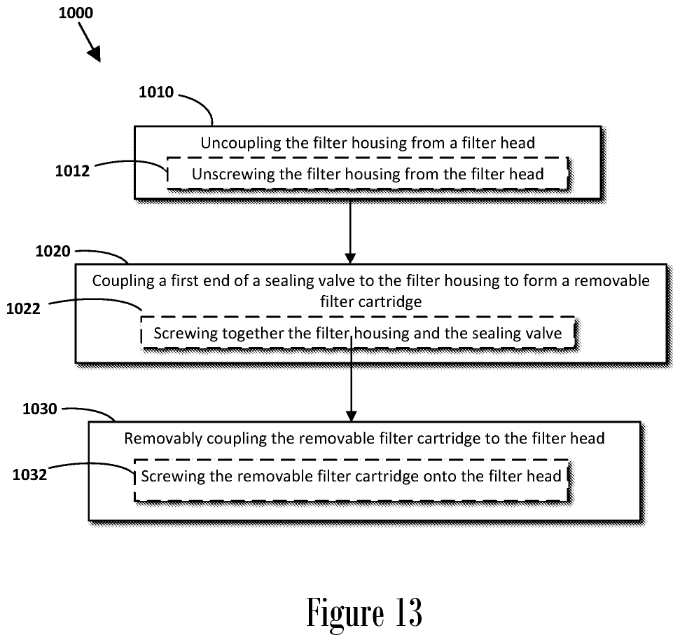

FIG. 13 shows a block flow diagram of a method 1000 of retrofitting a filter housing (e.g., filter housing 20 in FIG. 2, filter housing 120 in FIG. 8). The filter housing has an internal volume (e.g., internal volume 22, internal volume 122) containing a filter (e.g., filter 24, filter 124). For example, the method 1000 may be for retrofitting a filter housing (e.g., filter housing 120) that was originally intended to be directly removably coupled to a filter head (e.g., filter header 90, filter head 180). The method starts at 1010.

At 1010, the filter housing is uncoupled from a filter head. Removing the filter housing from the filter head 1010 includes uncoupling an open end of the filter housing (e.g., open end 26, open end 126) from the filter head. In an embodiment, uncoupling the filter housing from the filter head at 1010 may include unscrewing the filter housing form the filter head 1012. For example, unscrewing the filter housing from the filter head can include unscrewing a coupling nut of the filter housing (e.g., coupling nut 30, coupling nut 130) from the filter head. The method 1000 then proceeds to 1020.

At 1020, a first end (e.g., first end 46, first end 146) of a sealing valve (e.g., sealing valve 40, sealing valve 140) is coupled to the removable filter to form a removable filter cartridge (e.g., removable filter cartridge 10, removable filter cartridge 110). In an embodiment, coupling the sealing valve to the removable filter 1020 includes screwing together the filter housing and the sealing valve 1022. For example, screwing together the filter housing and the sealing valve 1022 can include screwing the coupling nut of the filter housing onto the sealing valve. The method 1000 then proceeds to 1030.

At 1030, the removable filter cartridge is removably coupled to the filter head. Removably coupling the cartridge to the filter head 1030 includes removably coupling a second end of the sealing valve (e.g., second end 48, second end 148) to the filter head. In an embodiment, removably coupling the removable filter cartridge to the filter head at 1030 may include screwing the removable filter cartridge onto the filter head 1032. For example, screwing the removable filter cartridge onto the filter head at 1032 may include screwing a coupling nut of the sealing valve (e.g., coupling nut 56, coupling nut 156) onto the filter head.

It should be appreciated that the method 1000 in an embodiment may be modified to include features as described above with respect to the filter assembly 1 in FIGS. 1-7 and/or the filter assembly 101 in FIGS. 8-12.

### Aspects

Any of Aspects 1-12 can be combined with any of Aspects 13-18, and any of Aspects 13-15 can be combined with any of Aspects 16-18.

Aspect 1. A removable filter cartridge, comprising: a filter housing with an internal volume containing a filter configured to filter a liquid; and a sealing valve including a first end coupled to an open end of the filter housing and a second end configured to removably couple the removable filter cartridge to a filter head, the sealing valve configured to be actuated between an open position and a closed position by one of sliding the sealing valve and rotating the filter housing, wherein the open position allows liquid flow into and out of the internal volume of the filter housing, and the closed position seals the internal volume of the filter housing, the sealing valve configured to be actuated from the open position to the closed position while the sealing valve is removably coupled to the filter head and maintain the seal while the removable filter cartridge remains uncoupled.

Aspect 2. The removable filter cartridge of Aspect 1, wherein the sealing valve is configured to be actuated by hand between the open position and the closed position.

Aspect 3. The removable filter cartridge of any one of Aspects 1 and 2, wherein the sealing valve includes a valve body, a valve plate, and an inlet passageway and an outlet passageway extending through the valve body and configured to direct the liquid into and from the filter housing, the valve plate in the closed position blocking the inlet passageway and the outlet passageway.

Aspect 4. The removable filter cartridge of Aspect 3, wherein the valve plate includes a first through hole and a second through hole, in the open position, the first through hole is aligned with the inlet passageway allowing the liquid to flow through the inlet passageway and the second through hole is aligned with the outlet passageway allowing liquid to flow through the outlet passageway, and in the closed position, a first portion of the valve plate blocks the inlet passageway and a second portion of the valve plate blocks the outlet passageway.

Aspect 5. The removable filter cartridge of Aspect 4, wherein the valve plate includes: a first side and a second side opposite to the first side, the first through hole extending through the valve body from the first side to the second side, a first seal on the first side of the valve plate surrounding the first through hole, the first seal configured to provide sealing between the valve plate and the valve body in the open position, and a second seal on the first side of the valve plate surrounding the first portion of the valve plate, the second seal configured to provide sealing between the valve plate and the valve body in the closed position.

Aspect 6. The removable filter cartridge of Aspect 5, wherein the valve plate includes: a third seal on the second side of the valve plate surrounding the first through hole, the first seal and the second seal configured to provide sealing between the valve plate and the valve body in the open position, and a fourth seal on the second side of the valve plate surrounding the first portion of the valve plate, the third seal and the fourth seal configured to provide sealing between the valve plate and the valve body in the closed position.

Aspect 7. The removable filter cartridge of any one of Aspects 1-4, wherein the sealing valve is configured to be actuated between the open position and the closed position by sliding the sealing valve, the sealing valve including a valve body coupled to the filter housing and a valve plate slidable in the valve body to actuate the sealing valve between the open position and the closed position.

Aspect 8. The removable filter cartridge of Aspect 7, wherein the sealing valve includes a handle affixed to the valve plate, the valve seal configured to be actuated between the open position and the closed position by pushing the handle towards the valve body and pulling the handle away from the valve body.

Aspect 9. The removable filter cartridge of claim 7, wherein the valve body has a substantially cylindrical shape with an axis, the valve plate has a substantially planar shape, and the valve plate moves between the open position and the closed position by moving along a direction at or about perpendicular to the axis of the substantially cylindrical shape of the valve body.

Aspect 10. The removable filter cartridge of any one of Aspects 1-4, wherein the sealing valve is configured to be actuated between the open position and the closed position by rotating the filter housing, the sealing valve including a valve body and a valve plate disposed in the valve body, the valve plate rotatably coupled to the filter housing such that the valve plate rotates with the filter housing relative to the valve body.

Aspect 11. The removable filter cartridge of Aspect 10, wherein the sealing valve includes the valve body and the valve plate disposed in the valve body, the valve plate rotatably coupled to the filter housing, the valve plate configured to be rotatable within the valve body.

Aspect 12. The removable filter cartridge of any one of any one of Aspects 10 and 11, wherein the valve plate includes a first through hole and a second through hole, in the open position, the first through hole is aligned with an opening of the inlet passageway allowing the liquid to flow through the inlet passageway and a second through hole is aligned with an opening of the outlet passageway allowing liquid to flow through the outlet passageway, and in the closed position, a first portion of the valve plate blocks the inlet passageway and a second portion of the valve plate extends across and blocks the outlet passageway, the first through hole and the second through hole each being in a rotated position relative to the opening of the inlet passageway and the opening of the outlet passageway, respectively.

Aspect 13. A sealing valve for a removable filter cartridge, the sealing valve comprising: the first end configured to be removably coupled to a filter head; and the second end configured to be coupled to a filter housing to form the removable filter cartridge, the filter housing having an internal volume containing a filter, the sealing valve configured to be actuated between an open position and a closed position by one of sliding the sealing valve and rotating the filter housing, wherein the open position is configured to direct fluid from the filter head into the filter housing and then from the filter housing back to the filter head, and the closed position is configured to seal the internal volume of the filter housing, the sealing valve configured to be actuated from the open position to the closed position while the sealing valve is removably coupled to the filter head and maintain the seal while the removable filter cartridge remains uncoupled.

Aspect 14. The sealing valve of Aspect 15, wherein the sealing valve is configured to be actuated between the open position and the closed position by sliding the sealing valve, the sealing valve including a valve body coupled to the filter housing and a valve body slidable in the valve body to actuate the sealing valve between the open position and the closed position.

Aspect 15. The sealing valve of Aspect 13, wherein the sealing valve is configured to be actuated between the open position and the closed position by rotating the filter housing, the sealing valve including a valve body and a valve plate disposed in the valve body, the valve plate rotatably coupled to the filter body such that the valve plate rotates with the filter housing relative to the valve body.

Aspect 16. A method of retrofitting a filter housing, the filter housing having an internal volume containing a filter, the method comprising: removing the filter housing from a filter head, which includes uncoupling an open end of the filter housing from the filter head; coupling a first end of a sealing valve to the open end of the filter housing to form a removable filter cartridge; removably coupling the removable filter cartridge to the filter head, which includes removably coupling a second end of the sealing valve to the filter head , the sealing valve is configured to be actuated between an open position and a closed position, wherein the open position is configured to direct fluid from the filter head into the filter housing and then from the filter housing back to the filter head, and the closed position is configured to seal the internal volume of the filter housing, the sealing valve configured to be actuated from the open position to the closed position while the sealing valve is removably coupled to the filter head and maintain the seal while the removable filter cartridge remains uncoupled.

Aspect 17. The method of claim 16, wherein the seal member includes a valve plate slidable in a valve body, the method further comprising: actuating the sealing valve between the open position and the closed position, which includes sliding the valve plate into the valve body.

Aspect 18. The method of claim 16, wherein the seal member includes a valve gate disposed in a valve body, the valve gate rotatable coupled to the filter housing, the method further comprising: actuating the sealing valve between the open position and the closed position, which includes partially uncoupling the filter housing from the sealing valve and rotating the filter housing to rotate the valve gate relative to the valve body.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A removable filter cartridge, comprising:
a filter housing with an internal volume containing a filter configured to filter a liquid; and
a sealing valve including a first end coupled to an open end of the filter housing and a second end configured to removably couple the removable filter cartridge to a filter head, the sealing valve configured to be actuated between an open position and a closed position by one of sliding the sealing valve and rotating the filter housing, wherein
the open position allows liquid flow into and out of the internal volume of the filter housing, and
the closed position seals the internal volume of the filter housing, the sealing valve configured to be actuated from the open position to the closed position while the sealing valve is removably coupled to the filter head and maintain the seal while the removable filter cartridge remains uncoupled.

2. The removable filter cartridge of claim 1, wherein the sealing valve is configured to be actuated by hand between the open position and the closed position.

3. The removable filter cartridge of claim 1, wherein the sealing valve includes a valve body, a valve plate, and an inlet passageway and an outlet passageway extending through the valve body and configured to direct the liquid into and from the filter housing, the valve plate in the closed position blocking the inlet passageway and the outlet passageway.

4. The removable filter cartridge of claim 3, wherein
the valve plate includes a first through hole and a second through hole,
in the open position, the first through hole is aligned with the inlet passageway allowing the liquid to flow through the inlet passageway and the second through hole is aligned with the outlet passageway allowing liquid to flow through the outlet passageway, and
in the closed position, a first portion of the valve plate blocks the inlet passageway and a second portion of the valve plate blocks the outlet passageway.

5. The removable filter cartridge of claim 4, wherein the valve plate includes:
a first side and a second side opposite to the first side, the first through hole extending through the valve body from the first side to the second side,
a first seal on the first side of the valve plate surrounding the first through hole, the first seal configured to provide sealing between the valve plate and the valve body in the open position, and
a second seal on the first side of the valve plate surrounding the first portion of the valve plate, the second seal configured to provide sealing between the valve plate and the valve body in the closed position.

6. The removable filter cartridge of claim 5, wherein the valve plate includes:
a third seal on the second side of the valve plate surrounding the first through hole, the first seal and the second seal configured to provide sealing between the valve plate and the valve body in the open position, and
a fourth seal on the second side of the valve plate surrounding the first portion of the valve plate, the third seal and the fourth seal configured to provide sealing between the valve plate and the valve body in the closed position.

7. The removable filter cartridge of claim 1, wherein the sealing valve is configured to be actuated between the open position and the closed position by sliding the sealing valve, the sealing valve including a valve body coupled to the filter housing and a valve plate slidable in the valve body to actuate the sealing valve between the open position and the closed position.

8. The removable filter cartridge of claim 7, wherein the sealing valve includes a handle affixed to the valve plate, the valve seal configured to be actuated between the open position and the closed position by pushing the handle towards the valve body and pulling the handle away from the valve body.

9. The removable filter cartridge of claim 7, wherein the valve body has a substantially cylindrical shape with an axis, the valve plate has a substantially planar shape, and the valve plate moves between the open position and the closed position by moving along a direction at or about perpendicular to the axis of the substantially cylindrical shape of the valve body.

10. The removable filter cartridge of claim 1, wherein the sealing valve is configured to be actuated between the open position and the closed position by rotating the filter housing, the sealing valve including a valve body and a valve plate disposed in the valve body, the valve plate rotatably coupled to the filter housing such that the valve plate rotates with the filter housing relative to the valve body.

11. The removable filter cartridge of claim 10, wherein the sealing valve includes the valve body and the valve plate disposed in the valve body, the valve plate rotatably coupled to the filter housing, the valve plate configured to be rotatable within the valve body.

12. The removable filter cartridge of claim 10, wherein the valve plate includes a first through hole and a second through hole,
in the open position, the first through hole is aligned with an opening of the inlet passageway allowing the liquid to flow through the inlet passageway and a second through hole is aligned with an opening of the outlet passageway allowing liquid to flow through the outlet passageway,
in the closed position, a first portion of the valve plate blocks the inlet passageway and a second portion of the valve plate extends across and blocks the outlet passageway, the first through hole and the second through hole each being in a rotated position relative to the opening of the inlet passageway and the opening of the outlet passageway, respectively.

13. A sealing valve for a removable filter cartridge, the sealing valve comprising:
the first end configured to be removably coupled to a filter head; and
the second end configured to be coupled to a filter housing to form the removable filter cartridge, the filter housing having an internal volume containing a filter, the sealing valve configured to be actuated between an open position and a closed position by one of sliding the sealing valve and rotating the filter housing, wherein
the open position is configured to direct fluid from the filter head into the filter housing and then from the filter housing back to the filter head, and
the closed position is configured to seal the internal volume of the filter housing, the sealing valve configured to be actuated from the open position to the closed position while the sealing valve is removably coupled to the filter head and maintain the seal while the removable filter cartridge remains uncoupled.

14. The sealing valve of claim 13, wherein the sealing valve is configured to be actuated between the open position and the closed position by sliding the sealing valve, the sealing valve including a valve body coupled to the filter housing and a valve body slidable in the valve body to actuate the sealing valve between the open position and the closed position.

15. The sealing valve of claim 13, wherein the sealing valve is configured to be actuated between the open position and the closed position by rotating the filter housing, the sealing valve including a valve body and a valve plate disposed in the valve body, the valve plate rotatably coupled to the filter body such that the valve plate rotates with the filter housing relative to the valve body.

16. A method of retrofitting a filter housing, the filter housing having an internal volume containing a filter, the method comprising:
removing the filter housing from a filter head, which includes uncoupling an open end of the filter housing from the filter head;
coupling a first end of a sealing valve to the open end of the filter housing to form a removable filter cartridge;
removably coupling the removable filter cartridge to the filter head, which includes removably coupling a second end of the sealing valve to the filter head, the sealing valve is configured to be actuated between an open position and a closed position, wherein
the open position is configured to direct fluid from the filter head into the filter housing and then from the filter housing back to the filter head, and
the closed position is configured to seal the internal volume of the filter housing, the sealing valve configured to be actuated from the open position to the closed position while the sealing valve is removably coupled to the filter head and maintain the seal while the removable filter cartridge remains uncoupled.

17. The method of claim 16, wherein the seal member includes a valve plate slidable in a valve body, the method further comprising:
actuating the sealing valve between the open position and the closed position, which includes sliding the valve plate into the valve body.

18. The method of claim 16, wherein the seal member includes a valve gate disposed in a valve body, the valve gate rotatable coupled to the filter housing, the method further comprising:
actuating the sealing valve between the open position and the closed position, which includes partially uncoupling the filter housing from the sealing valve and rotating the filter housing to rotate the valve gate relative to the valve body.
